(19) United States
(12) Patent Application Publication
(10) Pub. No.: US 2026/0274292 A1
(43) Pub. Date: Sep. 17, 2026

(54) AUTONOMOUS DRIVING VEHICLE

(71) Applicant: TOYOTA JIDOSHA KABUSHIKI KAISHA, Toyota-shi (JP)

(72) Inventors: Hiroto MURATA, Nagoya-shi (JP); Tetsuya MORINO, Susono-shi (JP)

(73) Assignee: TOYOTA JIDOSHA KABUSHIKI KAISHA, Toyota-shi (JP)

(21) Appl. No.: 19/409,026

(22) Filed: Dec. 4, 2025

(30) Foreign Application Priority Data
Jan. 20, 2025 (JP) 2025-007536

(51) Int. Cl. B60W 60/00; B60W 10/20; B60W 50/00

(52) U.S. Cl. CPC B60W 60/001; B60W 10/20; B60W 50/0098; B60W 2050/0056; B60W 2554/4041; B60W 2554/802; B60W 2554/804; B60W 2710/207

(57) ABSTRACT

An autonomous driving vehicle following a lead vehicle includes a controller. The controller is configured to determine a target turning index based on a relative position between an own vehicle and the lead vehicle at each point in time, the target turning index being a target of a turning index of the own vehicle. The lead vehicle is leading the own vehicle. The controller is configured to steer a wheel based on the target turning index. The controller is configured to apply a delay process to the target turning index when determining the target turning index.

### REFERENCE TO RELATED APPLICATIONS

This application claims priority from Japanese Patent Application No. 2025-7536 filed on Jan. 20, 2025. The entire content of the priority application is incorporated herein by reference.

### TECHNICAL FIELD

The present disclosure relates to an autonomous driving vehicle capable of following a vehicle.

### BACKGROUND ART

When a vehicle as a following vehicle follows another vehicle as a lead vehicle, for example, a technique described in Japanese Laid-Open Patent Publication No. 2017-65473 is used. The technique controls a driving of the following vehicle based on a traveling trajectory of the lead vehicle obtained by buffering.

### SUMMARY

The obtainment of the travel trajectory of the lead vehicle by the technology described in Japanese Laid-Open Patent Publication No. 2017-65473 requires the complicated process of sampling. There is much room for improvement in a technology for making a vehicle follow another vehicle, and it is possible to improve practicability of an autonomous driving vehicle by making some improvements. It is an object of the present disclosure to provide an autonomous driving vehicle having high practicability.

An aspect of the present disclosure relates to an autonomous driving vehicle following a lead vehicle. The autonomous driving vehicle includes a controller. The controller is configured to determine a target turning index based on a relative position between an own vehicle and the lead vehicle at each point in time, the target turning index being a target of a turning index of the own vehicle. The lead vehicle is leading the own vehicle. The controller is configured to steer a wheel based on the target turning index. The controller is configured to apply a delay process to the target turning index when determining the target turning index.

According to the autonomous driving vehicle of the present disclosure, since the target turning index is obtained at each point in time based on the relative positions of the lead vehicle and the own vehicle, it is possible to follow the immediately-lead vehicle by a simple process. In addition, the delay process also makes it possible to cope with a problem occurring at the time of turning, that is, a problem that the vehicle is driven inside the turning than the immediately-lead vehicle.

The autonomous driving vehicle (hereinafter sometimes referred to as the “Autonomous Driving Vehicle” or simply as the “Vehicle”) of the present disclosure may not be a vehicle capable of only autonomous driving, but may be operated by remote control, for example, or may be a vehicle capable of being driven by a driver, that is, manually driven.

If a control for following another vehicle is called a “following travel control”, the present vehicle executes the following travel control as a kind of an autonomous driving control. The following travel control may include not only the control (hereinafter, it may be sometimes referred to as a “turning control”) described above, that is, a steering control for steering the wheel, but also an “inter-vehicle distance control” which is a control of a distance between the lead vehicle and an own vehicle, in other words, a braking-driving force control for controlling a braking-driving force (which is a concept in which a driving force and a braking force are integrated) applied to the own vehicle.

An object to be followed in the following travel control (hereinafter, it may be sometimes referred to as “the present following running control”) executed by the present vehicle is the “lead vehicle”. The lead vehicle is not limited to a vehicle (hereinafter, it is sometimes referred to as an “immediately-lead vehicle”) traveling immediately ahead. If a vehicle following the lead vehicle is called a “following vehicle”, another following vehicle may exist between the lead vehicle and the present vehicle. This mode is, for example, a mode in which a plurality of following vehicles follow the lead vehicle in formation. From a viewpoint of good following, it is desirable that the lead vehicle is the immediately-lead vehicle. From this viewpoint, in the present disclosure, there will be mainly described a case in which the lead vehicle is the immediately-lead vehicle, in other words, a case in which the following vehicle follows the immediately-lead vehicle.

The lead vehicle in the following travel control may be an autonomous vehicle, a remotely controlled vehicle, or a vehicle driven by a driver. The “relative position to the lead vehicle” in the following travel control is a concept including a distance between the lead vehicle and the own vehicle and a relative bearing between the lead vehicle and the own vehicle. The “relative bearing” is a parameter indicating a direction in which the lead vehicle is positioned with respect to the present vehicle, that is, with respect to the own vehicle, and specifically, it can be considered to be an angle formed by a longitudinal axis of the own vehicle and a line connecting the lead vehicle and the own vehicle (hereinafter, it is sometimes referred to as a “lead vehicle direction line”). The relative position may be obtained by a general method using a sensor provided in the own vehicle, for example, a LiDAR, a millimeter-wave radar, a camera, or the like. Reference points for the relative position of the lead vehicle and the own vehicle are not particularly limited. In view of positioning the lead vehicle by the sensor provided in the own vehicle, the reference point of the lead vehicle may be, for example, a point at a center of a rear end surface of the lead vehicle. In other words, the lead vehicle may be positioned using that point as a point of interest. The reference point of the present vehicle, that is, the reference point of the own vehicle, may be, for example, set at a point where a center of gravity of the own vehicle exists in view of the fact that the following travel control is a control of the own vehicle's own travel.

Specifically, the above-described inter-vehicle distance control may be performed such that, for example, a target inter-vehicle distance as a target of the inter-vehicle distance between the lead vehicle and the own vehicle is determined, and the braking-driving force is controlled so that an actual inter-vehicle distance becomes the target inter-vehicle distance. The target inter-vehicle distance may be determined based on a traveling speed of the own vehicle or the lead vehicle in consideration of a possibility of rear-end collision by the own vehicle with the lead vehicle. On the other hand, as described above, the turning control is a control in which a target steering amount is determined based on the target turning index, and the wheels are steered such that an actual steering amount becomes the target steering amount. The “target turning index” is not particularly limited as long as the target steering amount can be determined. For example, a yaw rate of the own vehicle, a turning curvature of the own vehicle, a turning radius of the own vehicle, or the like may be adopted. From the viewpoint that the target steering amount can be determined by a relatively simple process, the turning index is preferably the turning curvature or the turning radius. Incidentally, since the turning curvature can be defined as a reciprocal of the turning radius, determining the steering amount based on the turning radius and determining the steering amount based on the turning curvature have the same meaning. It is noted that the turning control may be performed at all times, including the time of straight travel, since the straight travel of the vehicle can be considered as a turning in which the steering amount of the wheels becomes zero.

The “delay process” executed in the present following travel control is a process for coping with the above-mentioned problem occurring at the time of turning, that is, a problem in which a phenomenon of the present vehicle turning on the inside of the lead vehicle's path (Hereinafter, it is sometimes referred to as the “IN-cut phenomenon”.) occurs at the time of turning. In short, the IN-cut phenomenon is caused by the fact that the own vehicle starts turning at the time when the lead vehicle starts turning in the turning control described above. In consideration of this, the own vehicle may adopt two types of delay processes as exemplified below.

One of the two types is a process in which a value of the target turning index at a certain point in time is set to a value of the target turning index at a point in time following a delay time after the certain point in time. The “delay time” is a time for delaying the target turning index, and in short, this process is a process in which the target turning index is simply shifted later in time. Assuming that the traveling speed of the own vehicle and the traveling speed of the lead vehicle are substantially the same, the delay time may be determined, for example, by dividing the distance between the own vehicle and the lead vehicle by the traveling speed of the own vehicle or the lead vehicle. More specifically, the delay time may be determined by dividing the distance between the own vehicle and the lead vehicle at the point in time when the lead vehicle starts turning by the traveling speed of the own vehicle or the lead vehicle at the point in time. That is, in short, the delay time may be a time until the own vehicle reaches the position of the lead vehicle at which the turning has started. According to the delay process of this mode, the own vehicle can start turning at the point in time following the delay time after the point in time when the lead vehicle starts turning.

The other of the two types is a process including a low-pass filtering process performed on the target turning index. The “low-pass filtering process” is a process that can delay the phase of the target turning index in the change of the target turning index. In this low-pass filtering process, the lower a cutoff frequency, the longer the delay time. Therefore, based on the delay time, the longer the delay time, the lower the cutoff frequency is preferably set.

However, when the low-pass filtering process is performed, the value of the target turning index itself also becomes small. More specifically, the longer the delay time, that is, the lower the cutoff frequency, the smaller the target turning index becomes. Therefore, in order to compensate for the decrease in the target turning index, the delay process may include a correction process of multiplying the target turning index after the low-pass filtering process by an adjustment gain. The “adjustment gain” can be considered as a coefficient for adjusting the value of the target turning index, more specifically, a coefficient for increasing the value of the target turning index. From such a function, it is desirable to increase the adjustment gain as the cutoff frequency in the low-pass filtering process is lower. Further, the adjustment gain may be changed in accordance with the target turning index, more specifically, in accordance with the magnitude of the value of the target turning index. More specifically, for example, the target turning index may be increased only when the target turning index decreases to some extent. Specifically, for example, a peak value may be estimated from a variation of the target turning index, and the adjustment gain may be multiplied only when the target turning index has a value of 50% or more of the peak value.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which;

FIG. 1 is a schematic diagram illustrating a hardware configuration of an autonomous vehicle of an embodiment;

FIG. 2 is a schematic diagram illustrating a basic following travel control performed in the autonomous vehicle of the embodiment;

FIG. 3 is a diagram illustrating an IN-cut phenomenon that occurs when following a vehicle to turn;

FIG. 4 is a diagram for explaining a delay process for a target turning index performed in the autonomous vehicle according to the embodiment;

FIG. 5A is a graph for explaining a change in the target turning index by a first delay process which is one of the delay processes;

FIG. 5B is a graph for explaining a change in the target turning index by a second delay process which is the other of the delay processes;

FIG. 6 is a flowchart of a following travel control program executed in the autonomous driving vehicle of the embodiment;

FIG. 7 is a flowchart of a delay process subroutine which is a part of the following travel control program.

### DESCRIPTION

Hereinafter, an autonomous vehicle of an embodiment of the disclosure will be described in detail with reference to the drawings as the embodiment of the disclosure. It should be noted that, in addition to the following embodiments, the present disclosure can be embodied in various other embodiments in which various modifications and improvements are made based on the knowledge of a person skilled in the art.

### Configuration of Autonomous Driving Vehicle

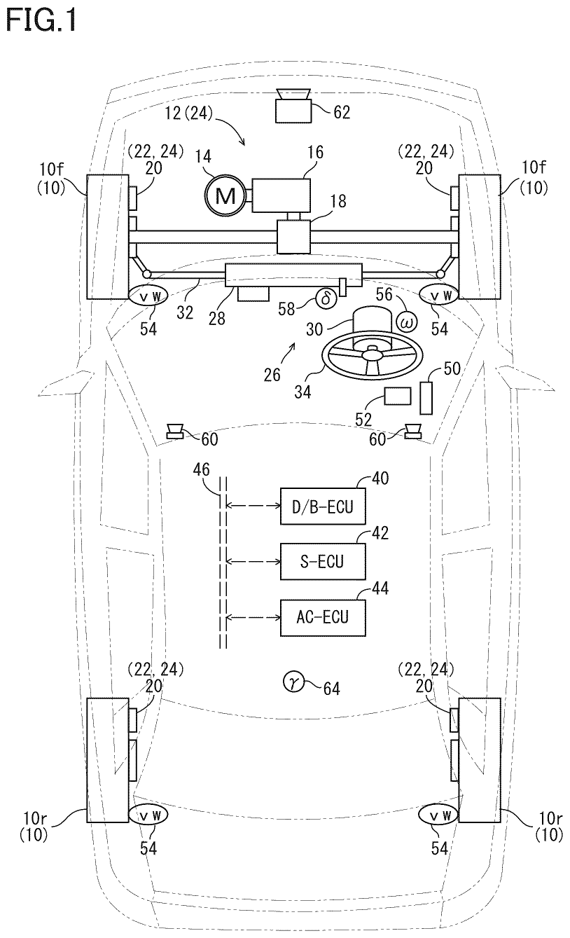

The autonomous vehicle (hereinafter sometimes referred to as an “Autonomous Driving Vehicle” or simply as a “present vehicle”) of the embodiment is a vehicle having left and right front wheels 10f and left and right rear wheels 10r, as shown schematically in FIG. 1. The front wheels 10f and the rear wheels 10r may be collectively sometimes referred to as wheels 10 when it is not necessary to distinguish between the front and rear wheels. The configuration of the present vehicle will be described below with reference to FIG. 1, but since the configuration is the same as that of a general vehicle except for a portion related to autonomous driving, which will be described later, the description will be made simply.

In the present vehicle, the front wheels 10f serve as drive wheels and are driven by a driving system 12. The present vehicle is a BEV (Battery Electric Vehicle), and the driving system 12 includes a drive motor 14 serving as a drive source, a transmission 16, a differential gear 18, and the like. Moreover, each of the four wheels 10 is provided with a wheel-brake-device 20. Each wheel-brake-device 20 is a general electric brake device and uses an electric motor as a drive source, although detailed description and illustration are omitted. The four wheel-brake-devices 20 constitute one braking system 22 of the present vehicle. Moreover, the driving system 12 and the braking system 22 constitute one braking-driving system 24 of the present vehicle.

In the present vehicle, the front wheels 10f are steering wheels, and a steering device 26 for steering the front wheels 10f is provided. The steering device 26 is a steer-by-wire type steering device, and has a steering actuator 28 and a reaction force actuator 30 mechanically separated from each other. The steering actuator 28 has a steering motor as a drive source, and the force of the steering motor causes a steering rod (rack bar) 32 to which the left and right front wheels 10f are respectively connected at left and right ends to move left and right, so that the left and right front wheels 10f are steered together. The reaction force actuator 30 holds a steering wheel 34 which is a steering operation member, and has a reaction force motor as a drive source to apply an operation reaction force to the steering wheel 34 against the operation of the steering wheel 34.

The present vehicle is equipped with a braking-driving electronic control unit 40 for controlling the braking-driving system 24, a steering electronic control unit 42 for controlling the steering device, and an autonomous driving electronic control unit 44 for executing the autonomous driving of the present vehicle, which are connected to a CAN (Controllable Area Network or Car Area Network) 46. Hereinafter, these units may be sometimes referred to as the braking-driving ECU 40, the steering ECU 42, and the autonomous driving ECU 44. Incidentally, the braking-driving ECU 40 includes a computer, the drive motor 14, a driver (drive circuit) of an electric motor of each of the wheel-brake-devices 20, and the like, the steering ECU 42 includes a computer, a driver of a steering motor, a driver of a reaction force motor, and the like, and the autonomous driving ECU 44 includes a computer as a main component. It is noted that these ECUs 40, 42, and 44 constitute one controller of the present vehicle.

Moreover, the present vehicle is provided with an accelerator pedal 50 as an accelerator operating member and a brake pedal 52 as a brake operating member, which are also connected to the CAN 46. In addition, the present vehicle is provided with, as sensors, wheel speed sensors 54 each for detecting a rotational speed (hereinafter, sometimes referred to as a “wheel speed”) vw of each wheel 10, an operation angle sensor 56 for detecting an operation angle ω of the steering wheel 34 as a steering operation amount, a steering angle sensor 58 for detecting a steering angle δ of the front wheel 10f as a steering amount, two cameras 60 and a millimeter-wave radar 62 for monitoring the front of the vehicle, and a yaw rate sensor 64 for detecting a yaw rate γ. These sensors are also connected to the CAN 46. It is noted that, in present vehicle, the steering angle δ is detected as a movement amount in a left and right direction of the steering rod 32.

The present vehicle is capable of manual driving, that is, the present vehicle can be driven by a driver. Briefly, in the manual driving, the braking-driving ECU 40 determines a driving force Fd to be applied to the present vehicle based on an operation amount of the accelerator pedal 50, and controls the driving system 12 based on the driving force Fd. Further, the braking-driving ECU 40 determines a braking force Fb to be applied to the present vehicle based on an operation amount of the brake pedal 52, controls regenerative braking by the driving system 12 based on the braking force Fb, and controls the braking system 22 to generate a supplemental amount of the braking force Fb that is insufficient in the regenerative braking. Incidentally, the braking-driving ECU 40 has a function of detecting a traveling speed of the own vehicle (hereinafter, it is sometimes referred to as an “own vehicle speed”) vo based on the wheel speed vw of each of the wheels 10. It is noted that, in the following description, a combination of the driving force Fd and the braking force Fb is treated as a braking-driving force Fd/b.

Further, in the manual driving, the steering ECU 42 determines a target steering angle δ*, which is a target of the steering angle δ of the front wheel 10f, based on the operation angle ω of the steering wheel 34 according to the following equation:

$${δ}^{*} = η \cdot ω η : steering gear ratio$$

The steering ECU 42 controls the steering device 26 so that an actual steering angle δ becomes the target steering angle δ*.

### Following Travel Control

The present vehicle also performs autonomous driving not dependent on the operation of the driver. An autonomous driving control, which is a control for the autonomous driving, is executed by the autonomous driving ECU 44. When following the lead vehicle, the autonomous driving ECU 44 executes a following travel control (hereinafter, it may be sometimes referred to as the “present following travel control”) as a type of autonomous driving control. The following travel control will be described in detail below, but first, a following travel basic control which is the basis of the following travel control will be described, and then, the contents of the present following travel control will be described in order.

### Following Travel Basic Control

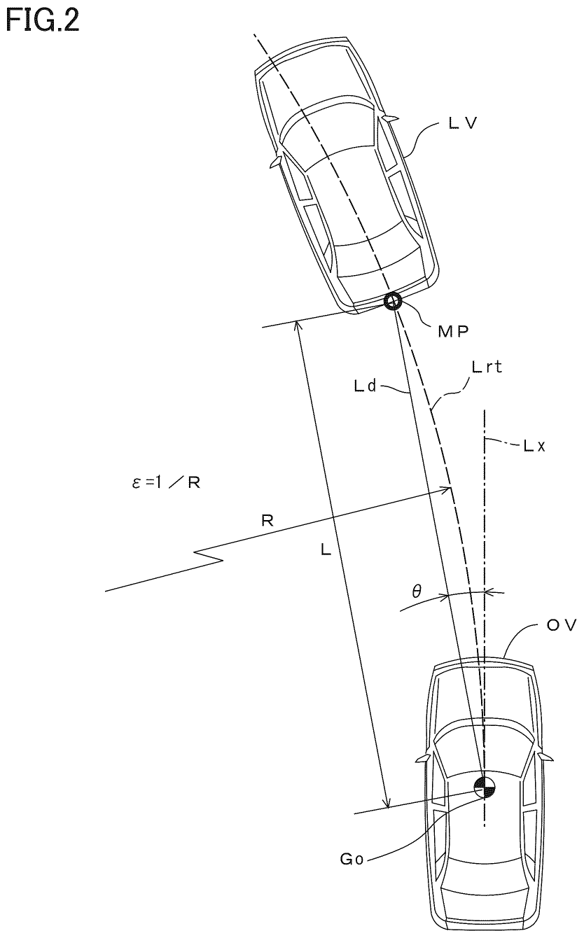

As shown in FIG. 2, the autonomous driving ECU 44 basically obtains a relative position between a lead vehicle LV and the present vehicle (hereinafter sometimes referred to as the “own vehicle”) OV which is the following vehicle, and executes the following travel control based on the relative position. The relative position includes an inter-vehicle distance L between the lead vehicle LV and the own vehicle OV and a relative-bearing angle θ which is a relative bearing. The relative-bearing angle θ is a parameter indicating a direction in which the lead vehicle LV is positioned relative to the own vehicle. More specifically, the autonomous driving ECU 44 specifies a point of interest MP as a reference for the relative position of the lead vehicle LV from information obtained by the two cameras 60 and the millimeter-wave radar 62, and measures the inter-vehicle distance L as a distance between the point of interest MP and a position of a center of gravity Go as a reference for the own vehicle OV. Further, the autonomous driving ECU 44 specifies a lead vehicle direction line Ld as a line connecting the point of interest MP and the position of the center of gravity Go, and measures an angle formed by the lead vehicle direction line Ld and a longitudinal axis line Lx of the own vehicle OV as the relative-bearing angle θ. Incidentally, the point of interest MP is set at a center of a rear end surface of the lead vehicle LV.

In the present following travel control, a turning curvature ε is adopted as an index for turning of the own vehicle OV, that is, as a turning index, and the autonomous driving ECU 44 then determines a turning travel line Lrt, which is a travel line Lr for moving the own vehicle OV at the current time to the position of the lead vehicle LV at the current time in turning, based on the inter-vehicle distance L and the relative-bearing angle θ, and determines the turning curvature ε of the turning travel line Lrt as a target turning curvature ε*. Incidentally, the turning curvature ε is an inverse of a turning radius R. The obtainments of the inter-vehicle distance L and the relative-bearing angle θ and the determination of the target turning curvature ε* are performed at each point in time. Specifically, they are iteratively performed at a set control time pitch Δt (for example, tens of msec to hundreds of msec).

The following travel control includes an inter-vehicle distance control for controlling the inter-vehicle distance L between the lead vehicle LV and the own vehicle OV, and a turning control for turning the own vehicle OV. The inter-vehicle distance control may be referred to as a braking-driving force control for controlling the braking-driving force Fd/b applied to the own vehicle OV, and the turning control may be referred to as a steering angle control for controlling the steering angle δ of the front wheel 10f of the own vehicle OV. Since the concept of turning includes a case in which the steering angle δ becomes 0, that is, a state in which the vehicle is traveling straight, the turning control is also executed when the vehicle is traveling straight. Incidentally, the target turning curvature ε* when the vehicle is traveling straight and following is determined to be 0.

In the inter-vehicle distance control, the braking-driving force Fd/b is controlled so that the inter-vehicle distance L becomes a target inter-vehicle distance L*. More specifically, the autonomous driving ECU 44 specifies the own vehicle speed vo detected by the braking-driving ECU 40 as described above, and specifies a lead vehicle speed vl, which is the traveling speed of the lead vehicle LV, based on the own vehicle speed vo and an inter-vehicle distance change speed (dL/dt), which is a change speed of the inter-vehicle distance L, according to the following equation:

$$v l = v o + ( dL / dt ) \cdot Δ t$$

The target inter-vehicle distance L* is determined to be larger as the lead vehicle speed vl increases in consideration of the possibility of rear-end collision by the own vehicle OV with the lead vehicle LV, using a vehicle speed-dependent determination coefficient ξ, according to the following equation:

$${L}^{*} = L 0 + ξ \cdot vl L 0 : reference inter - vehicle distance$$

The autonomous driving ECU 44 determines the braking-driving force Fd/b to be applied to the own vehicle OV according to a PD feedback control law, specifically according to the following equation, based on an inter-vehicle distance deviation ΔL (=L*−L) which is a deviation of the actual inter-vehicle distance L from the determined target inter-vehicle distance L*.

$$Fd / b = β p \cdot Δ L + β d \cdot ( d Δ L / dt )$$

Note that βp is a proportional term gain and βd is a differential term gain.

The autonomous driving ECU 44 transmits information indicating the determined braking-driving force Fd/b to the braking-driving ECU 40, and the braking-driving ECU 40 controls the braking-driving system 24, more specifically, the driving system 12 and the braking system 22, based on the braking-driving force Fd/b as in the case of the manual driving described above. Specifically, when the braking-driving force Fd/b is positive, the braking-driving ECU 40 controls the driving system 12 based on the braking-driving force Fd/b as the driving force Fd to be applied, and when the braking-driving force Fd/b is negative, the braking-driving ECU 40 generates the regenerative braking force in the driving system 12 and controls the braking system 22 to generate a supplemental amount that is insufficient in the regenerative braking force based on the braking-driving force Fd/b as the braking force Fb to be applied.

In the turning control in the following travel basic control (hereinafter, it is sometimes referred to as a “turning basic control”), the autonomous driving ECU 44 adopts the turning curvature ε determined as described above as the target turning curvature ε* (a kind of a target turning index). Based on the target turning curvature ε*, the autonomous driving ECU 44 determines the target steering angle δ* which is the steering angle δ of the front wheel 10f to be realized, and transmits information about the target steering angle δ* to the steering ECU 42. The steering ECU 42 controls the steering actuator 28 so that the actual steering angle δ becomes the target steering angle δ*. It is noted that the process for determining the braking-driving force Fd/b and the process for determining the target steering angle δ* may be repeated at the set control time pitch Δt.

### Problems in Turning Basic Control

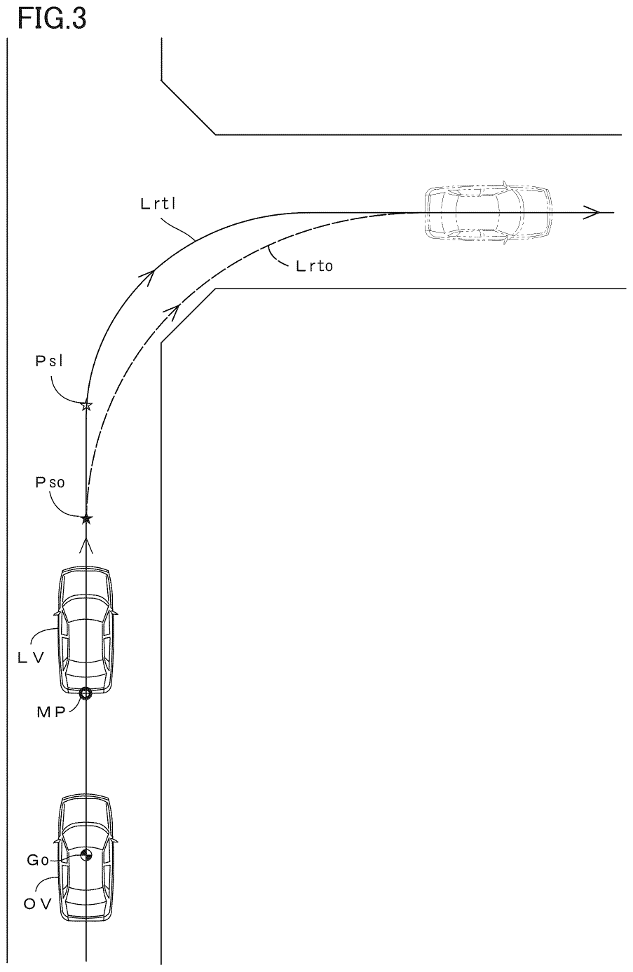

When the turning basic control described above is executed, an IN-cut phenomenon occurs. The IN-cut phenomenon is a phenomenon in which, as shown in FIG. 3, when the own vehicle OV follows the turning lead vehicle LV and turns, the own vehicle OV travels on an own vehicle turning travel line Lrto which is positioned inside a lead vehicle turning travel line Lrtl. The lead vehicle turning travel line Lrtl is the turning travel line Lrt when the lead vehicle LV turns. The own vehicle turning travel line Lrto is the turning travel line Lrt that is positioned inside the lead vehicle turning travel line Lrtl. To put it simply, this phenomenon is caused by the fact that the relative-bearing angle θ deviates from 0 at the timing when the lead vehicle LV starts turning, and the own vehicle OV also starts turning at that time. Specifically, this is because the lead vehicle LV starts turning from a lead vehicle turning start position Psl indicated by a “white star symbol”, while the own vehicle OV starts turning from an own vehicle turning start position Pso indicated by a “black star symbol”.

Due to the above-described IN-cut phenomenon, the own vehicle OV cannot properly follow the vehicle when turning. In an extreme case, the IN-cut phenomenon may cause the own vehicle OV to interfere with an object such as a structure existing inside the turning. Therefore, in the present vehicle, the problem caused by the IN-cut phenomenon is handled by adding improvements to the basic turning control. Details of the handling processes will be described below.

### Delay Process

The process for coping with the above-described IN-cut phenomenon is, in short, a process for temporally delaying the target turning curvature ε* which is the target turning index, that is, a delay process. In the present vehicle, two processes, that is, a first delay process and a second delay process, are prepared as the delay process, and one of the two processes is executed according to a predetermined setting for the vehicle. It is noted that the mode in which the first delay process is executed may be called a first delay process mode, and the mode in which the second delay process is executed may be called a second delay process mode. Hereinafter, the first delay process and the second delay process will be successively described in detail. For the purpose of simplifying the description, the following description will be made on the assumption that the lead vehicle LV turns with the turning curvature ε which is a constant value.

### First Delay Process

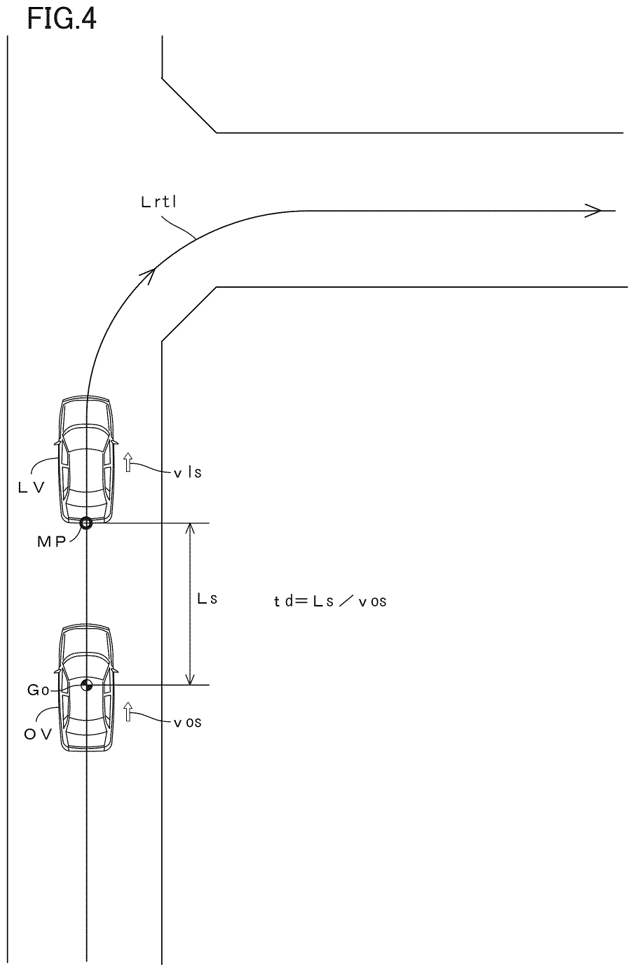

The first delay process is a process in which, in a turn, a value of the target turning curvature ε* at a certain point in time is set to a value of the target turning curvature ε* at a point in time following a delay time td, which is a specific time, after the certain point in time. In other words, the process simply delays the target turning curvature ε* by the delay time td. Referring to FIG. 4, which shows the state at a time when the lead vehicle LV followed by the own vehicle OV starts turning, the autonomous driving ECU 44 determines the delay time td by dividing a turning start inter-vehicle distance Ls, which is the inter-vehicle distance L at the time when the lead vehicle LV starts turning, by a turning start own vehicle speed vos, which is the own vehicle speed vo at the time when the lead vehicle LV starts turning, according to the following equation:

$$t d = Ls / vos$$

Incidentally, the delay time td may be determined by dividing the turning start inter-vehicle distance Ls by a turning start lead vehicle speed vls, which is the lead vehicle speed vl at the time when the lead vehicle LV starts turning.

The autonomous driving ECU 44 stores the target turning curvature ε* determined for each of the control time pitches Δt in accordance with the turning basic control, between a time point backward by a set time from the current time point and the current time point, and determines a prior target turning curvature ε*−td, which is the target turning curvature ε* determined before the delay time td from the current time point, as the target turning distance rate ε* at the current time point. It should be noted that the set time during which the target turning curvature ε* is stored may be, for example, a time sufficient for one turn to be completed in consideration of the control time pitch Δt.

Moreover, the autonomous driving ECU 44 determines as the start time point of the first delay process a time point when it can be determined that the relative-bearing angle θ of the lead vehicle LV has departed from 0, specifically, a time point when the absolute value of the relative-bearing angle θ exceeds a threshold angle θth set to a value close to 0, and determines as the end time point of the first delay process a time point when it can be determined that the delayed target turning curvature ε* has become 0, specifically, a time point when the absolute value of the target turning curvature ε* becomes less than a threshold curvature εth set to a value close to 0. The autonomous driving ECU 44 executes the first delay process between the start time point and the end time point.

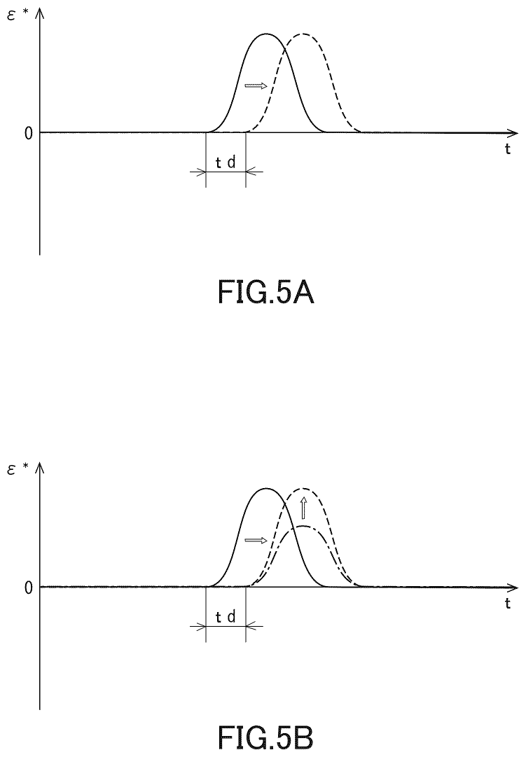

FIG. 5A is a graph showing a temporal change of the target turning curvature ε* of the following own vehicle OV when the lead vehicle LV turns. The solid line shows the target turning curvature ε* obtained by the turning basic control described above, and the broken line shows the target turning curvature ε* subjected to the first delay process during turning. As can be seen from this graph, by executing the first delay process, the target turning curvature ε* is determined during turning with the delay time td. By the process, the following own vehicle OV turns approximately along the lead vehicle turning travel line Lrtl of the lead vehicle LV.

### Second Delay Process

The second delay process is a process including a low-pass filter process applied to the target turning curvature ε* obtained by the turning basic control. This low-pass filter process can delay the phase of the change of the target turning curvature ε*, and a detailed description thereof is omitted here. When the autonomous driving ECU 44 applies the low-pass filter process, the target turning curvature ε* is determined with a delay during turning, as shown by a dash-dot line in the graph of FIG. 5B. Incidentally, the time for delaying the target turning curvature ε* depends on a cutoff frequency fl in the low-pass filter process. Specifically, as the cutoff frequency fl is lower, the delay time becomes larger (longer). Therefore, in the second delay process, similarly to the first delay process, the autonomous driving ECU 44 determines the delay time td as the time to be delayed by dividing the turning start inter-vehicle distance Ls, which is the inter-vehicle distance L at the time when the lead vehicle LV starts turning, by the turning start own vehicle speed vos or the turning start lead vehicle speed vls, and determines the cutoff frequency fl by using a cutoff frequency determination function fl (td) having the delay time td as a parameter.

According to the low-pass filter process, while the target turning curvature ε* can be delayed as described above, the amplitude of the target turning curvature ε*, that is, the value of the target turning curvature ε* itself becomes smaller. Therefore, in the second delay process, the autonomous driving ECU 44 executes a correction process in which the target turning curvature ε* subjected to the low-pass filter process is multiplied by an adjustment gain K according to the following equation:

$${ε}^{*} = K \cdot {ε}^{*}$$

According to the low-pass filter process, the value of the target turning curvature ε* becomes smaller as the cutoff frequency fl becomes lower, and it is desirable to adjust the value of the target turning curvature ε* to a larger value as the value of the target turning curvature ε* becomes larger, or to make adjust the value of the target turning curvature ε* to a larger value only when the value of the target turning curvature ε* becomes larger to some extent. Therefore, the autonomous driving ECU 44 determines the adjustment gain K by using an adjustment gain determination function K (fl, ε*) having the cutoff frequency fl and the target turning curvature ε* themselves as parameters. Specifically, the adjustment gain K may be determined to a value of about 1.1~1.5, for example. By the correction process, the target turning curvature ε* is corrected as shown by the broken line in the graph of FIG. 5B.

Similarly to the first delay process, the autonomous driving ECU 44 determines the start time point and the end time point, and executes the second delay process between the start time point and the end time point. The second delay process described above also causes the own vehicle OV, which is the following vehicle, to turn approximately along the lead vehicle turning travel line Lrtl of the lead vehicle LV.

### Flow of Following Travel Control

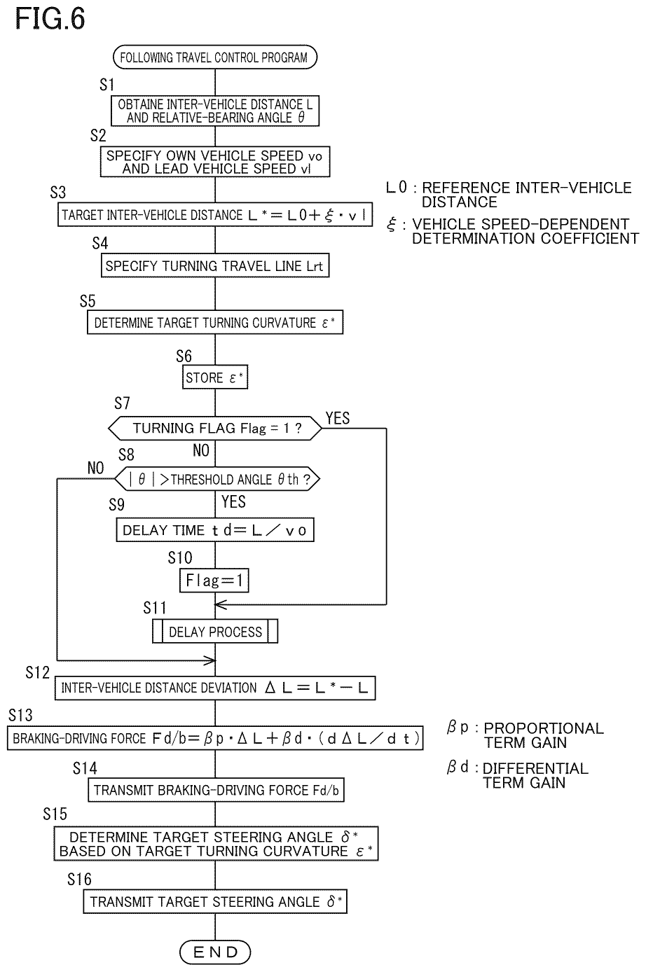

The following travel control described above is executed by the autonomous driving ECU 44 by repeatedly executing a following travel control program shown in a flowchart in FIG. 6 at the control time pitch Δt described above. The flow of the following travel control process will be briefly described below along the program.

In the process according to the following travel control program, first, in step 1 (hereinafter, it is abbreviated as “S1” and the following steps are similar), the inter-vehicle distance L and the relative-bearing angle θ, which are the relative positions to the lead vehicle LV, are obtained, and in step S2, the own vehicle speed vo, which is the travel speed of the own vehicle OV, and the lead vehicle speed vl, which is the travel speed of the lead vehicle LV and the lead vehicle speed vl, which is the running speed of both LVs, are specified. In step S3, the target inter-vehicle distance L* is determined based on a reference headway distance L0, the lead vehicle speed vl, and the vehicle speed-dependent determination coefficient ξ, as described above. In step S4, the turning travel line Lrt is specified based on the inter-vehicle distance L and the relative-bearing angle θ, and in step S5, the target turning curvature ε* is determined based on the turning travel line Lrt. In step S6, the target turning curvature ε* is stored.

In step S7, the value of the turning flag Flag indicating whether or not the vehicle is turning is determined. The turning flag Flag is a flag which is “1” when the vehicle is turning and “0” when the vehicle is not turning. When the turning flag Flag is “0”, it is determined in step S8 whether the absolute value of the relative-bearing angle θ exceeds the threshold angle θth. When the absolute value of the relative-bearing angle θ exceeds the threshold angle θth, the current inter-vehicle distance L (the turning start inter-vehicle distance Ls) is divided by the current own vehicle speed vo (the turning start own vehicle speed vos) in step S9 to determine the delay time td. Then, the turning flag Flag is set to “1” in step S10, and the delay process is executed in step S11. When it is determined in step S7 that the turning flag Flag is “1”, S8~S10 are skipped, and the delay process is executed in S11. When it is determined in S8 that the absolute value of the relative-bearing angle θ does not exceed the threshold angle θth, the delay process in S11 is skipped.

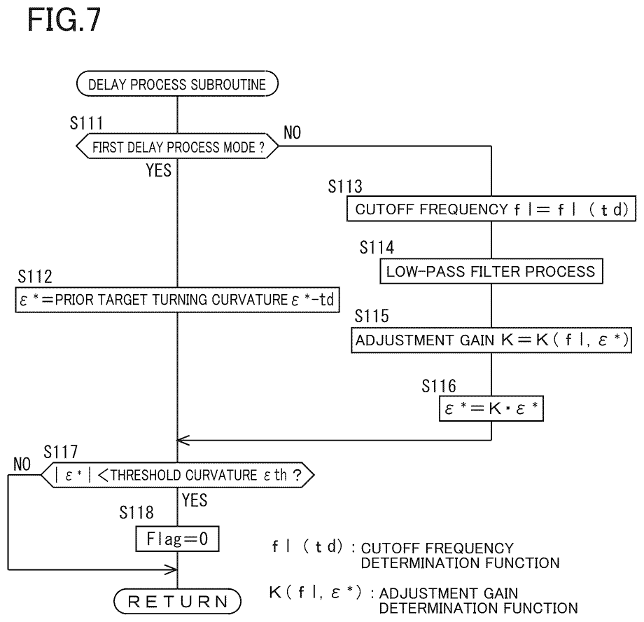

The delay process in S11 is executed by executing a delay process subroutine shown in a flowchart in FIG. 7. In the process according to this subroutine, first, in step S111, it is determined whether the mode of the delay process is the first delay process mode or not. When the mode is the first delay process mode, the first delay process is executed. Specifically, in step S112, the prior target turning curvature ε*−td, which is the target turning curvature ε* determined only before the delay time td, is specified from the stored plurality of target turning curvatures ε*, and the determined target turning curvature ε* is replaced with the specified prior target turning curvature ε*−td, thereby determining the current target turning curvature ε*.

When the mode is not the first delay process mode, that is, when the mode is the second delay process mode, in step S113, the cutoff frequency fl in the low-pass filter process is determined using the cutoff frequency determination function fl (td) having the delay time td as a parameter, and in step S114, the low-pass filter process based on the cutoff frequency fl is executed. In step S115, the adjustment gain K is determined by using the adjustment gain determination function K (fl, ε*) having the target turning curvature ε* obtained by the low-pass filtering process and the cutoff frequency fl as parameters, target turning curvature ε*. In step 116, the target turning curvature ε* is corrected by multiplying the target turning curvature ε* obtained by low-pass filtering by the determined adjustment gain K. That is, the target turning curvature ε* at the current time is determined.

After the target turning curvature ε* at the current time is determined, it is determined in step S117 whether or not the absolute value of the target turning curvature ε* is less than the threshold curvature εth. When the absolute value of the target turning curvature ε* is less than the threshold curvature εth, it is determined that the turning has been completed and the turning flag Flag is set to “0” in step S118. When the absolute value of the target turning curvature ε* is greater than or equal to the threshold curvature εth, step S118 is skipped.

After the execution of the delay process or the skip of the delay process, in step S12, the inter-vehicle distance deviation ΔL, which is a deviation of the inter-vehicle distance L at the current time from the determined target inter-vehicle distance L*, is specified, and in step S13, the braking-driving force Fd/b to be generated is determined based on the inter-vehicle distance deviation ΔL in accordance with the PD feedback control law. Information about the braking-driving force Fd/b is transmitted to the braking-driving ECU 40 in step S14. Subsequently, in step S15, the target steering angle δ*, which is the steering angle δ of the front wheel 10f to be realized, is determined based on the determined target turning curvature ε*, and information about the target steering angle δ* is transmitted to the steering ECU 42 in step S16. When the own vehicle OV is following the lead vehicle LV in the straight-ahead state, the target turning curvature ε* is determined to be 0, and the target turning angle δ* is also determined to be 0.

What is claimed is

1. An autonomous driving vehicle following a lead vehicle, comprising a controller,
wherein the controller is configured to determine a target turning index based on a relative position between an own vehicle and the lead vehicle at each point in time, the target turning index being a target of a turning index of the own vehicle, the lead vehicle leading the own vehicle,
wherein the controller is configured to steer a wheel based on the target turning index, and
wherein the controller is configured to apply a delay process to the target turning index when determining the target turning index.

2. The autonomous driving vehicle according to claim 1,
wherein the delay process is a process in which a value of the target turning curvature at a certain point in time is set to a value of the target turning curvature at a point in time following a delay time after the certain point in time, the delay time being a time for delaying the target turning index.

3. The autonomous driving vehicle according to claim 2,
Wherein the delay time is a time determined by dividing a distance between the own vehicle and the lead vehicle by a traveling speed of the own vehicle or the lead vehicle.

4. The autonomous driving vehicle according to claim 1,
wherein the delay process is a process including a low-pass filtering process performed on the target turning index.

5. The autonomous driving vehicle according to claim 4,
wherein, a cutoff frequency in the low-pass filtering process becomes lower as the delay time is longer.

6. The autonomous driving vehicle according to claim 5,
wherein the delay time is a time determined by dividing a distance between the own vehicle and the lead vehicle by a traveling speed of the own vehicle or the lead vehicle.

7. The autonomous driving vehicle according to claim 4,
wherein the delay process includes a process of multiplying the target turning index after the low-pass filtering process by an adjustment gain.

8. The autonomous driving vehicle according to claim 7,
wherein the adjustment gain becomes larger as a cutoff frequency in the low-pass filtering process is lower.

9. The autonomous driving vehicle according to claim 7,
wherein the adjustment gain is changed in accordance with the target turning index.
